(19) United States
(12) Patent Application Publication
(10) Pub. No.: US 2009/0154420 A1
(43) Pub. Date: Jun. 18, 2009

(54) METHOD OF AND APPARATUS FOR MANAGING NEIGHBOR NODE HAVING SIMILAR CHARACTERISTIC TO THAT OF ACTIVE NODE AND COMPUTER-READABLE RECORDING MEDIUM HAVING RECORDED THEREON PROGRAM FOR EXECUTING THE METHOD

(75) Inventors: Yong-ku KIM, Suwon-si (KR); Cheol-ju HWANG, Yongin-si (KR); Soo-hong PARK, Gwangiu-si (KR); Min-ho LEE, Gwacheon-si (KR); Sang-wook CHO, Suwon-si (KR); Pyoung-yun KIM, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/144,989

(22) Filed: Jun. 24, 2008

(30) Foreign Application Priority Data
Dec. 12, 2007 (KR) 2007-129081

(51) Int. Cl. H04Q 7/00

(52) U.S. Cl. 370/331

(57) ABSTRACT

A method and apparatus for managing a neighbor node having a similar characteristic to that of an active node, the method including: generating a neighbor list containing information about at least one neighbor node; selecting at least one parent node from among the at least one neighbor node; determining fitness parameters using a characteristic value of the active node, characteristic values of the at least one neighbor node included in the neighbor list of the active node, and characteristic values of at least one neighbor node included in a neighbor list of each parent node; and updating the neighbor list of the active node according to values of the determined fitness parameters.

### CROSS-REFERENCE TO RELATED APPLICATION

This application claims the benefit of Korean Patent Application No. 2007-129081, filed Dec. 12, 2007 in the Korean Intellectual Property Office, the disclosure of which is incorporated herein by reference.

### BACKGROUND OF THE INVENTION

1. Field of the Invention

Aspects of the present invention relate to a method of managing a neighbor node having a similar characteristic to that of an active node, and more particularly, to a method of and apparatus for managing a neighbor node having a high fitness based on characteristic values of nodes of a network, using an active node, and a computer-readable recording medium having recorded thereon a program for executing the method

2. Description of the Related Art

In general, a node is connected to a network and includes an identifier (ID) and a characteristic value. An active node refers to a node that currently plays a key role in a node search from among nodes that are connected to a network. FIG. 1 illustrates a conventional system in which an active node searches for a neighbor node having a high fitness. Referring to FIG. 1, the system includes an active node 110 and a server 120.

The active node 110 sends a query requesting the server 120 to search for a node (not shown) having a high fitness as determined by the active node 110 in operation 1. The server 120 stores IDs and characteristic values of all nodes connected to a network. Upon receipt of the query from the active node 110, the server 120 executes a search process using the stored IDs and characteristic values in operation 2 and sends a search result to the active node 110 in operation 3. In other words, all nodes register their IDs and characteristic values with the server 120, and the active node 110 requests a node (for example, a neighbor node) having a high fitness as determined by the active node from the server 120.

FIG. 2 is a flowchart illustrating a conventional method of searching for a neighbor node having a high fitness determined by an active node 110. Referring to FIG. 2, in operation 210, the active node 110 accesses a server 120 on a network. In operation 220, the server 120 determines whether the active node 110 is accessing the server 120 for the first time. If so, the server 120 registers an ID and a characteristic value of the active node 110 in operation 230. In operation 240, the active node 110 requests the server 120 to search for a node having a high fitness with the active node 110. In operation 250, the server 120 compares the characteristic value of the active node 110 with characteristic values of all other nodes registered in the server 120 to find a node having a high fitness with the active node 110. Accordingly, the server 120 sends a search result to the active node 110 in operation 260.

However, this conventional method can only be executed with the server 120. That is, this conventional method cannot be executed when the server 120 is not operating. Moreover, when a large number of nodes access the server 120 in the network, a great deal of time is required to search for a node having a high fitness and a heavy load may be imposed on the server 120. For example, when 400,000 nodes are connected to the server 120, the server 120 must search through all 400,000 nodes connected to the server 120 when the active node 110 requests a neighbor node having a high fitness. Therefore, as the number of nodes accessing the server 120 increases, the time required for the node search and the load imposed on the server 120 also increase.

### SUMMARY OF THE INVENTION

Aspects of the present invention provide a method and apparatus for managing a neighbor node whereby a neighbor node having a high fitness determined by an active node can be found on a network without the use of a server, and a computer-readable recording medium having recorded thereon a program for executing the method. Aspects of the present invention also provide a method and apparatus for managing a neighbor node whereby a neighbor node having a high fitness determined by an active node can be found on a network within a minimum period of time, and a computer-readable recording medium having recorded thereon a program for executing the method.

According to an aspect of the present invention, there is provided a method of managing a neighbor node having a similar characteristic to that of an active node, the method including: generating a neighbor list including information about at least one neighbor node; selecting at least one parent node from among the at least one neighbor node; determining fitness parameters using a characteristic value of the active node, characteristic values of the at least one neighbor node included in the neighbor list of the active node, and characteristic values of at least one neighbor node included in a neighbor list of each parent node; and updating the neighbor list of the active node based on values of the determined fitness parameters.

In an aspect of the invention, the information about the at least one neighbor node may include identifiers (IDs) and/or connection information of the at least one neighbor node.

In an aspect of the invention, the generating of the neighbor list may include receiving the information about the at least one neighbor node from a server that stores IDs and connection information of nodes that are currently connected to a network, and/or a node that is currently connected to the network.

In an aspect of the invention, the selecting of the at least one parent node may include: receiving the characteristic value of the at least one neighbor node included in the neighbor list of the active node; determining the fitness parameters using the characteristic value of the active node and the characteristic values of the at least one neighbor node included in the neighbor list of the active node; arranging the at least one neighbor node included in the neighbor list of the active node based on values of the fitness parameters; and selecting a predetermined number of parent nodes from the neighbor nodes included in the neighbor list of the active node according to the arrangement.

In an aspect of the invention, the selecting of the predetermined number of parent nodes may include: dividing the arranged neighbor nodes into high-fitness neighbor nodes and low-fitness neighbor nodes according to the values of the determined fitness parameters; and selecting all of the high-fitness neighbor nodes and some of the low-fitness neighbor nodes.

In an aspect of the invention, the determining of the fitness parameters may include: receiving the neighbor list of each parent node; receiving characteristic values of the at least one neighbor node included in the neighbor list of each parent node; and calculating the fitness parameters using a predetermined equation.

In an aspect of the invention, the updating of the neighbor list of the active node may include: arranging the at least one neighbor node included in the neighbor list of the active node and the at least one neighbor node included in the neighbor list of each parent node based on values of the fitness parameters; selecting a predetermined number of neighbor nodes from the at least one neighbor node included in the neighbor list of the active node and the at least one neighbor node included in the neighbor list of each parent node according to the arrangement; and updating the neighbor list of the active node using the selected neighbor nodes.

In an aspect of the invention, the selecting of the predetermined number of neighbor nodes may include: dividing the arranged neighbor nodes into high-fitness neighbor nodes and low-fitness neighbor nodes based on the values of the fitness parameters; and selecting all of the high-fitness neighbor nodes and some of the low-fitness neighbor nodes.

In an aspect of the invention, the method may further include adding information about a node that accesses the active node to the neighbor list of the active node.

In an aspect of the invention, the selecting of the at least one parent node, the determining of the fitness parameters, and the updating of the neighbor list of the active node may be repeated in a periodic manner and/or in response to an update request from a user.

According to another aspect of the present invention, there is provided an apparatus for managing a neighbor node having a similar characteristic to that of an active node, the apparatus including: a neighbor list generation unit to generate a neighbor list containing information about at least one neighbor node; a parent node selection unit to select at least one parent node from among the at least one neighbor node; a fitness parameter determination unit to determine fitness parameters using a characteristic value of the active node, characteristic values of the at least one neighbor node included in the neighbor list of the active node; and characteristic values of at least one neighbor node included in a neighbor list of each parent node; and a neighbor list update unit updating the neighbor list of the active node according to values of the determined fitness parameters.

In an aspect of the invention, the information about the at least one neighbor node may include identifiers (IDs) and/or connection information of the at least one neighbor node.

In an aspect of the invention, the neighbor list generation unit may receive the information about the at least one neighbor node from a node that is currently connected to a network, and/or from a server that stores IDs and/or connection information of nodes that are currently connected to the network.

In an aspect of the invention, the parent node selection unit may include: a characteristic value reception unit to receive the characteristic values of the at least one neighbor node included in the neighbor list of the active node; a parameter determination unit to determine the fitness parameters using the characteristic value of the active node and the characteristic values of the at least one neighbor node included in the neighbor list of the active node; a node arrangement unit to arrange the at least one neighbor node included in the neighbor list of the active node based on the values of the fitness parameters; and a node selection unit to select a predetermined number of parent nodes from among the at least one neighbor node included in the neighbor list of the active node according to the arrangement.

In an aspect of the invention, the node selection unit may divide the arranged neighbor nodes into high-fitness neighbor nodes and low-fitness neighbor nodes according to the values of the determined fitness parameters and select all of the high-fitness neighbor nodes and some of the low-fitness neighbor nodes.

In an aspect of the invention, the fitness parameter determination unit may include: a neighbor list reception unit to receive the neighbor list of each parent node; a characteristic value reception unit to receive characteristic values of the at least one neighbor node included in the neighbor list of each parent node; and a parameter calculation unit to calculate the fitness parameters using a predetermined equation.

In an aspect of the invention, the neighbor list update unit may include: a node arrangement unit to arrange the at least one neighbor node included in the neighbor list of the active node and the at least one neighbor node included in the neighbor list of each parent node based on the values of the fitness parameters; a node selection unit to select a predetermined number of neighbor nodes from among the neighbor nodes included in the neighbor list of the active node and the neighbor list of each parent node according to the arrangement; and an update unit to update the neighbor list of the active node using the selected neighbor nodes.

In an aspect of the invention, the node selection unit may include: a division unit to divide the arranged neighbor nodes into high-fitness neighbor nodes and low-fitness neighbor nodes based on the values of the fitness parameters; and a selection unit to select all of the high-fitness neighbor nodes and some of the low-fitness neighbor nodes.

In an aspect of the invention, the neighbor list update unit may add information about a node that accesses the active node to the neighbor list of the active node.

In an aspect of the invention, the he apparatus may further include a control unit to repeat updating the neighbor list of the active node in a periodic manner and/or in response to an update request from a user.

According to another aspect of the present invention, there is provided a computer-readable recording medium having recorded thereon a program for executing a method of managing a neighbor node having a similar characteristic to that of an active node, the method including: generating a neighbor list including information about at least one neighbor node; selecting at least one parent node from among the at least one neighbor node; determining fitness parameters using a characteristic value of the active node, characteristic values of the at least one neighbor node included in the neighbor list of the active node, and characteristic values of at least one neighbor node included in a neighbor list of each parent node; and updating the neighbor list of the active node according to values of the determined fitness parameters.

According to yet another aspect of the present invention, there is provided a system of managing nodes in a network, the system including: a plurality of neighbor nodes connected to the network; and an active node for managing neighbor nodes having similar characteristics to the active node, the active node including: a neighbor list generation unit to generate a neighbor list including information about at least one neighbor node, a parent node selection unit to select at least one parent node from among the at least one neighbor node, a fitness parameter determination unit to determine fitness parameters by using a characteristic value of the active node, characteristic values of the at least one neighbor node included in the neighbor list of the active node, and characteristic values of at least one neighbor nodes included in a neighbor list of each parent node, and a neighbor list update unit to update the neighbor list of the active node according to values of the determined fitness parameters.

According to still another aspect of the present invention, there is provided a method of managing a neighbor node having a similar characteristic to that of an active node, the method including: selecting at least one parent node from among at least one determined neighbor node; determining fitness parameters by using a characteristic value of the active node, characteristic values of the at least one determined neighbor node, and characteristic values of at least one neighbor node included in a neighbor list of each parent node; and generating a neighbor list of the active node including one or more neighbor nodes based on the fitness parameters.

According to another aspect of the present invention, there is provided an apparatus for determining neighbor nodes having a similar characteristic to that of an active node, the apparatus including: a fitness parameter determination unit to determine fitness parameters by using a characteristic value of the active node, characteristic values of neighbor nodes of the active node, and characteristic values of neighbor nodes of selected neighbor nodes of the active node.

According to yet another aspect of the present invention, there is provided a method of managing a neighbor node having a similar characteristic to that of an active node, the method including: selecting parent nodes from among neighbor nodes of the active node; determining fitness parameters of the nodes using a characteristic value of the active node, characteristic values of the neighbor nodes of the active node, and characteristic values of neighbor nodes of each parent node; generating a neighbor list of the active node including neighbor nodes based on the fitness parameters; and transmitting characteristic values of the neighbor nodes included in the generated neighbor list to a neighbor node that determines other neighbor nodes having similar characteristics thereto.

According to still another aspect of the present invention, there is provided a method of managing a neighbor node having a similar characteristic to that of an active node, the method including: a method of managing a neighbor node having a similar characteristic to that of an active node, the method including: contacting at least one parent node from among neighbor nodes known to the active node to obtain a list of parent neighbor nodes not known to the active node; determining fitness parameters by using a characteristic value of contacted parent neighbor nodes included in a neighbor list of each contacted parent node; and generating a neighbor list of the active node based on the fitness parameters.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a conventional system in which an active node searches for a neighbor node having a high fitness;

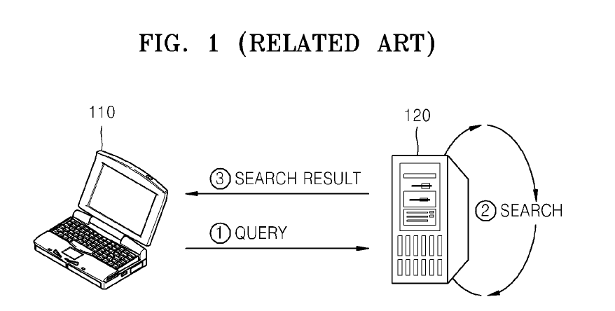

FIG. 2 is a flowchart illustrating a conventional method of searching for a neighbor node having a high fitness determined by an active node;

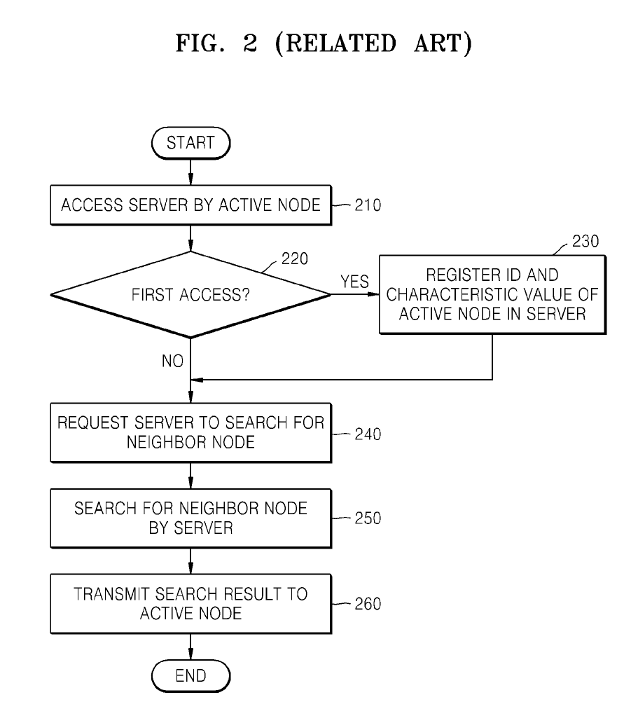

FIG. 3 is a block diagram illustrating an apparatus for managing a neighbor node, according to an embodiment of the present invention;

FIG. 4 is a diagram illustrating an example of an active node information field generated by a neighbor list generation unit illustrated in FIG. 3, according to an embodiment of the present invention;

FIG. 5 is a flowchart illustrating a method of managing a neighbor node, according to an embodiment of the present invention;

FIG. 6 is a flowchart illustrating a method of selecting a parent node using the apparatus of FIG. 3, according to an embodiment of the present invention;

FIG. 7 is a flowchart illustrating a method of determining a fitness parameter, according to an embodiment of the present invention; and

FIG. 8 is a flowchart illustrating a method of updating a neighbor list of an active node, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

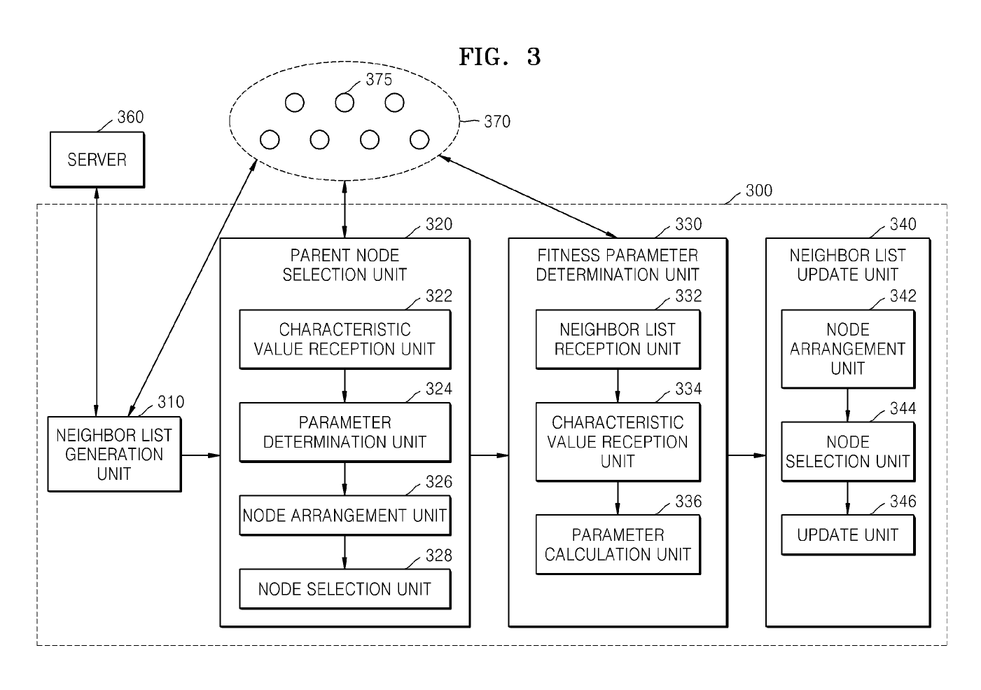

FIG. 3 is a block diagram illustrating an apparatus 300 for managing a neighbor node, according to an embodiment of the present invention. Referring to FIG. 3, the apparatus 300 is designed to manage a neighbor list in order to quickly find nodes having high degrees of fitness as determined by an active node in a network. To this end, the apparatus 300 includes a neighbor list generation unit 310, a parent node selection unit 320, a fitness parameter determination unit 330, and a neighbor list update unit 340.

Nodes 370 are connected to a network and each of the nodes 370 stores an identifier (ID) and a neighbor list. An active node is a node that plays a key role in node searches from among the nodes 370 connected to the network, and may further include the apparatus 300 illustrated in FIG. 3. Hereinafter, a neighbor node refers to a node having a similar characteristic to that of the active node based on a fitness parameter described below. It is understood that the neighbor node is not necessarily a node that is physically adjacent to the active node. Rather, the neighbor node is a node determined to have a high fitness as determined by the active node. The number of neighbor nodes determined by the active node can be arbitrarily determined by a user, or can be predetermined as a default setting. The neighbor list refers to a group of neighbor nodes.

The neighbor list generation unit 310 generates a neighbor list including information on at least one neighbor node. The information on each neighbor node may include an ID and/or connection information (such as a uniform resource locator (URL) or an Internet protocol (IP) address of the neighbor node). The information on the at least one neighbor node may be obtained from a server 360 that stores information about the nodes 370 currently connected to the network. For example, the server 360 selects at least one arbitrary node 375 from the currently connected nodes 370 and sends information about the selected node 375 to the neighbor list generation unit 310. The neighbor list generation unit 310 receives information about the node 375 from the server 360 and generates the neighbor list accordingly. The number of neighbor nodes included in the generated neighbor list can be arbitrarily determined by a user, can be set to a default limit, or can be unlimited.

According to other aspects, the neighbor list generation unit 310 may directly receive information about the arbitrary node 375 that is currently connected to the network and generate the neighbor list accordingly. For example, the neighbor list generation unit 310 may request, from some or all of the nodes 370 connected to the network, information about the nodes and generate the neighbor list using information of a node that is received first. Alternatively, the neighbor list generation unit 310 may send, to an arbitrary IP address, a request for transmission of node information and generate the neighbor list using node information transmitted from a node having the IP address. As such, the information can be received in a peer-to-peer fashion and/or through a server 360.

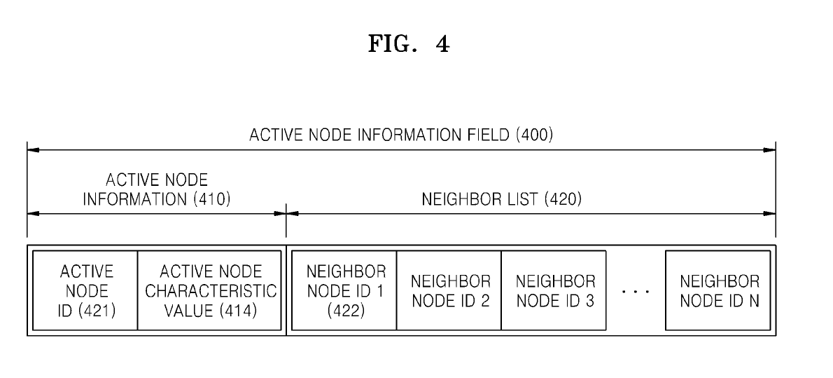

FIG. 4 is a diagram illustrating an example of an active node information field 400 generated by the neighbor list generation unit 310 illustrated in FIG. 3, according to an embodiment of the present invention. Referring to FIG. 4, the active node information field 400 includes active node information 410 having an active node ID 421, an active node characteristic value 414, and a neighbor list 420 having one or more neighbor node IDs 422. Herein, a node maintains its neighbor list at all times. The field 400 can be sent to other nodes 370 and is received from selected nodes 370 on request to determine fitness of that node and to identify that node's neighbors as will be explained below.

The neighbor node ID 422 is used to identify a neighbor node and includes connection information of the neighbor node. The number of neighbor nodes included in a neighbor list managed by each node can be set arbitrarily. The active node characteristic value 414 is used to characterize an active node, and various values may be used for the active node characteristic value 414, according to an embodiment of the present invention. The active node characteristic value 414 can be a single value or a plurality of values according aspects of the present invention.

Referring back to FIG. 3, the parent node selection unit 320 selects one or more parent nodes from among the neighbor nodes included in the neighbor list 420 generated by the neighbor list generation unit 310. The one or more parent nodes are selected to retrieve one or more neighbor lists on the network, and a predetermined number of nodes except for the active node can be selected as the one or more parent nodes. Such selection of the one or more parent nodes is used to prevent a neighbor list 420 from circulating among identical neighbor lists when updating the neighbor list. For example, the one or more parent nodes may be a predetermined number of nodes that are selected at random from neighbor nodes included in the neighbor list. The parent node selection unit 320 includes a characteristic value reception unit 322, a parameter determination unit 324, a node arrangement unit 326, and a node selection unit 328.

The characteristic value reception unit 322 receives characteristic values of the neighbor nodes included in the neighbor list of an active node. The neighbor list of the active node is generated by the neighbor list generation unit 310, and the characteristic value reception unit 322 accesses the neighbor nodes included in the neighbor list of the active node in order to read the characteristic values of the neighbor nodes. By way of example, the character value reception unit 322 can request each neighbor node included on the generated neighbor list to provide the corresponding field 400.

The parameter determination unit 324 determines a fitness parameter using a characteristic value of the active node and the characteristic values of the neighbor nodes included in the neighbor list of the active node. A relationship equation for determining the fitness parameter may take various forms according to aspects of the present invention. Furthermore, when a plurality of neighbor nodes are included in the neighbor list of the active node, the parameter determination unit 324 determines a plurality of fitness parameters. For example, in a system including nodes having particular points (positions) as characteristic values, a distance between the points may be a fitness parameter. In this case, fitness=|characteristic value of active node−characteristic value of neighbor node|. A relationship equation for determining the fitness parameter may also take a relatively complex form, such as: fitness=(mod(characteristic value of active node, 2)*3)−(mod(characteristic value of neighbor node, 2)*3).

The node arrangement unit 326 arranges the neighbor nodes included in the neighbor list of the active node based on values of the fitness parameter determined by the parameter determination unit 324. Various methods may be used to arrange the neighbor nodes according to aspects of the present invention. For example, the node arrangement unit 326 may arrange the neighbor nodes in a descending order of the fitness. Then, the node selection unit 328 selects a predetermined number of parent nodes from the neighbor nodes included in the neighbor list of the active node using an arrangement result of the node arrangement unit 326. For example, if the number of neighbor nodes included in the neighbor list is 8, the number of parent nodes is 4, and IDs of the neighbor nodes included in the neighbor list generated by the neighbor list generation unit 310 are [2 6 7 5 1 3 4 9], four neighbor nodes having the highest degrees of fitness are selected as the parent nodes from the arranged neighbor nodes. Thus, if the arrangement of neighbor nodes in a descending order of a fitness parameter based on the determined fitness parameters results in [5 7 9 4 1 2 3 6], the parent nodes are [5 7 9 4].

It is understood that aspects of the present invention are not limited to the above method of determining fitness parameters and selecting parent nodes accordingly. For example, according to other aspects, the node selection unit 328 may divide the arranged neighbor nodes into high-fitness neighbor nodes and low-fitness neighbor nodes based on degrees of fitness (such as in a descending order of fitness), and may then select all of the high-fitness neighbor nodes and some of the low-fitness neighbor nodes as the parent nodes. Hereinafter, a predetermined number of neighbor nodes having high degrees of fitness will be referred to as high-fitness neighbor nodes and the remaining nodes will be referred to as low-fitness neighbor nodes. The node selection unit 328 may select some of the high-fitness neighbor nodes and some of the low-fitness neighbor nodes as the parent nodes. The node selection unit 328 may also select a predetermined number of nodes from each of the high-fitness neighbor nodes and from each of the low-fitness neighbor nodes in a sequential order or at random. The number of parent nodes selected from the high-fitness neighbor nodes and the low-fitness neighbor nodes may vary according to aspects of the present invention. For example, if the number of neighbor nodes included in a neighbor list is 8, the number of parent nodes is 4, the number of high-fitness neighbor nodes is 4, IDs of the neighbor nodes included in the neighbor list generated by the neighbor list generation unit 310 are [2 6 7 5 1 3 4 9], and the arrangement of the neighbor nodes by the node arrangement unit 326 results in [5 7 9 4 1 2 3 6], the high-fitness neighbor nodes are [5 7 9 4] and low-fitness neighbor nodes are [1 2 3 6]. Accordingly, the node selection unit 328 may randomly select (number of parent nodes/2) from high-fitness neighbor nodes and (number of parent nodes/2) from low-fitness neighbor nodes as parent nodes. In this case, the node selection unit 328 may select [7 4] and [2 6] as the parent nodes. However, it is understood that according to other aspects, the parent node selection can be performed in other ways, such as random selection or selection from each of divided portions of an arranged neighbor list.

The fitness parameter determination unit 330 determines a fitness parameter using a characteristic value of an active node, characteristic values of neighbor nodes included in a neighbor list of the active node, and characteristic values of neighbor nodes included in a neighbor list of each of parent nodes. The fitness parameter determination unit 330 includes a neighbor list reception unit 332, a characteristic value reception unit 334, and a parameter calculation unit 336.

The neighbor list reception unit 332 receives a neighbor list of each of the parent nodes selected by the parent node selection unit 320. The characteristic value reception unit 334 receives characteristic values of neighbor nodes included in each neighbor list received by the neighbor list reception unit 332 from each of the parent nodes in the nodes 370. By way of example, the neighbor list reception unit 332 could request each parent node provide corresponding fields 400. The parameter calculation unit 336 calculates fitness parameters using a predetermined equation. A method of calculating the fitness parameters is similar to that described for the parameter determination unit 324 of the parent node selection unit 320. However, the parameter calculation unit 336 calculates the fitness parameters using the characteristic value of the active node, the characteristic values of the neighbor nodes included in the neighbor list of the active node, and the characteristic values of the neighbor nodes included in the neighbor list of each of the parent nodes.

For example, if the IDs of neighbor nodes included in a neighbor list of an active node are [2 6 7 5 1 3 4 9], IDs of parent nodes are [5 7 9 4], and a neighbor list of each of the parent nodes is as follows:
Neighbor list of parent node 5=[52 53 56 51 58 55 54 59]
Neighbor list of parent node 6=[63 62 60 64 67 66 65 69]
Neighbor list of parent node 9=[95 94 96 91 92 95 97 90]
Neighbor list of parent node 4=[40 43 48 41 47 45 44 49],
   the parameter calculation unit 336 calculates fitness parameters for [5 7 9 4 1 2 3 6 52 53 56 51 58 55 54 59 63 62 60 64 67 66 65 69 95 94 96 91 92 95 97 90 40 43 48 41 47 45 44 49]. Since [(number of neighbor nodes of active node)+((number of neighbor nodes of parent nodes)×(number of parent nodes))=8+(8×4)=40], the parameter calculation unit 336 calculates fitness parameters for a total of 40 nodes.

The neighbor list update unit 340 updates the neighbor list of the active node based on values of the fitness parameter determined by the fitness parameter determination unit 330. The neighbor list update unit 340 includes a node arrangement unit 342, a node selection unit 344, and an update unit 346. The node arrangement unit 342 arranges the neighbor nodes included in the neighbor list of the active node and the neighbor nodes included in the neighbor list of each of the parent nodes. For example, the node arrangement unit 342 may arrange nodes in a descending order of fitness values. The node selection unit 344 selects a predetermined number of neighbor nodes to be updated from the neighbor nodes included in the neighbor list of the active node and the neighbor nodes included in the neighbor list of each of the parent nodes using an arranged result of the node arrangement unit 342. The predetermined number of neighbor nodes corresponds to the size of the neighbor list of the active node. A method of selecting neighbor nodes by the node selection unit 344 of the neighbor list update unit 340 is similar to that described for the node selection unit 328 of the parent node selection unit 320. However, the node selection unit 344 selects the neighbor nodes to be updated from the neighbor nodes included in the neighbor list of the active node as well as the neighbor nodes included in the neighbor list of each of the parent nodes.

In an embodiment of the present invention, the node selection unit 344 may include a division unit (not shown) and a selection unit (not shown). The division unit divides the arranged neighbor nodes into high-fitness neighbor nodes and low-fitness neighbor nodes based on fitness parameters, and the selection unit selects all of the high-fitness neighbor nodes and some of the low-fitness neighbor nodes. For example, if the number of neighbor nodes included in a neighbor list is 8, the number of high-fitness neighbor nodes is 4, and arrangement of the node arrangement unit 342 results in [74 60 3 29 6 63 22 44 65 43 21 28 47 24 4 77 62 69 7 75 5 96 1 23 71 26 72 25 75 90 9 40 66 48 67 41 2 64 45 49], the high-fitness neighbor nodes can be [74 60 3 29] and the low-fitness neighbor nodes can be [6 63 22 44 65 43 21 28 47 24 4 77 62 69 7 75 5 96 1 23 71 26 72 25 75 90 9 40 66 48 67 41 2 64 45 49]. Thus, the node selection unit 344 may select [74 60 3 29] from the high-fitness neighbor nodes and randomly select [77 5 26 90] from the low-fitness neighbor nodes. As a result, the neighbor list of the active node can be updated to [74 60 3 29 77 5 26 90].

The update unit 346 updates the neighbor list of the active node using the neighbor nodes selected by the node selection unit 344. For example, the update unit 346 may select a predetermined number (corresponding to the size of the neighbor list) of nodes having high degrees of fitness from the arranged nodes to update the neighbor list of the active node. For example, if the arrangement of the nodes in a descending order of fitness values results in [94 60 3 59 6 63 52 44 65 43 51 58 47 54 4 97 62 69 7 95 5 96 1 53 91 56 92 55 95 90 9 40 66 48 67 41 2 64 45 49], the update unit 346 may update the neighbor list of the active node to be [94 60 3 59 6 63 52 44].

The apparatus 300 may further include a control unit (not shown) to update a neighbor list of an active node in a periodic manner or in response to an update request from a user. The control unit may control the neighbor list of the active node to have higher degrees of fitness as determined by the active node from all nodes connected to a network, by controlling the units 310, 320, 330, 340 to repeat the above-described update process several times. Such a control unit may be in the form of a computer and/or processor housing the units 310, 320, 330, 340.

Furthermore, the neighbor list update unit 346 may add information about an external node that accesses the active node to the neighbor list of the active node. In this case, the size of the neighbor list of the active node increases. When the external node accesses the active node in order to update its neighbor list, the neighbor list update unit 346 adds information about the external node to the neighbor list of the active node. The apparatus 300 then determines a fitness parameter by further referring to the added information and arranges nodes in order to update the neighbor list of the active node. When the information about the external node is added to the neighbor list of the active node, the size of the neighbor list may increase, but the node selection unit 344 may then reduce the size of the neighbor list by reselecting nodes corresponding to the size of the neighbor list in order to maintain the original size of the neighbor list. The information about the external node is added to the neighbor list of the active node in order to update the neighbor list of the active node in consideration of the external node that is newly connected to the network.

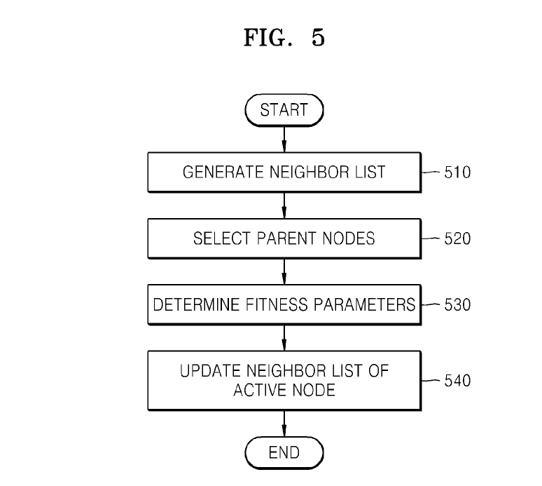

FIG. 5 is a flowchart illustrating a method of managing a neighbor node, according to an embodiment of the present invention. Referring to FIG. 5, an apparatus for managing a neighbor node (such as illustrated in FIG. 3) generates a neighbor list of an active node including information about at least one neighbor node in operation 510. The information about the at least one neighbor node includes IDs and/or connection information of each of the at least one neighbor node. In order to generate the neighbor list, the apparatus may receive the information about the at least one neighbor node from a server. In this case, the server stores IDs and/or connection information of nodes that are currently connected to the network. However, it is understood that aspects of the present invention are not limited to a server storing the information about the at least one neighbor node. For example, the apparatus may receive the information about the at least one neighbor node from a node that is currently connected to the network. In this case, the node stores its ID and/or connection information.

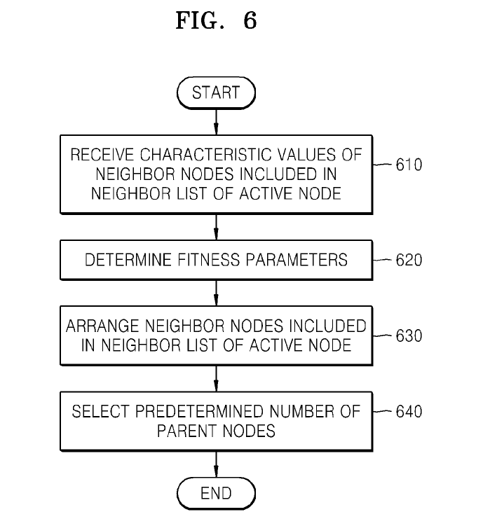

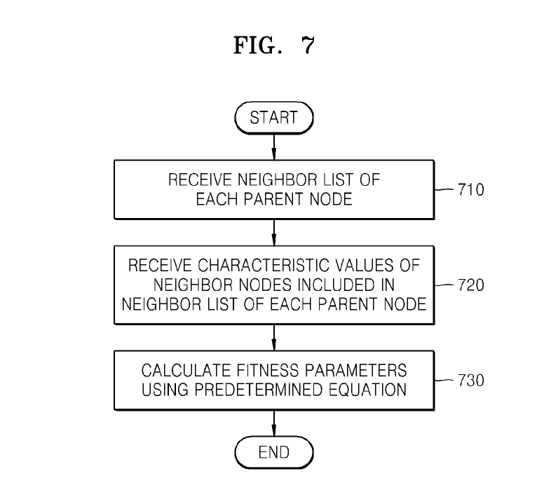

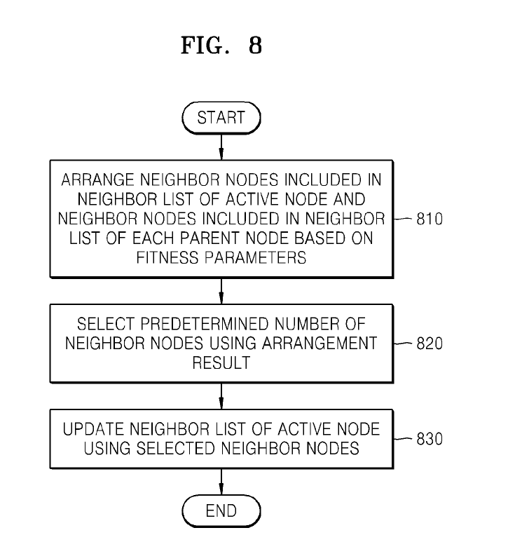

In operation 520, the apparatus selects parent nodes using a characteristic value of the active node and characteristic values of the neighbor nodes included in the neighbor list of the active node. The selecting of the parent nodes will be described in more detail later with reference to FIG. 6. In operation 530, the apparatus determines fitness parameters using the characteristic value of the active node, the characteristic values of the neighbor nodes included in the neighbor list of the active node, and characteristic values of neighbor nodes included in a neighbor list of each of the parent nodes. The determining of the fitness parameters will be described in more detail later with reference to FIG. 7. In operation 540, the apparatus updates the neighbor list of the active node based on values of the fitness parameter determined in operation 530. The updating of the neighbor list of the active node will be described in more detail later with reference to FIG. 8.

The method illustrated in FIG. 5 may further include adding information about an external node that accesses the active node to the neighbor list of the active node. Moreover, the method illustrated in FIG. 5 may further include repeating operations 520 through 540 in a periodic manner and/or in response to an update request from a user.

FIG. 6 is a flowchart illustrating a method of selecting parent nodes using an apparatus for managing neighbor nodes (such as the apparatus 300 illustrated in FIG. 3), according to an embodiment of the present invention. Referring to FIG. 6, in operation 610, the apparatus 300 receives characteristic values of neighbor nodes included in a neighbor list of an active node from the neighbor nodes. Such values can be received directly from the parent nodes and/or from a server. In operation 620, the apparatus 300 determines fitness parameters using the characteristic value of the active node and the characteristic values of the neighbor nodes included in the neighbor list. In operation 630, the apparatus 300 arranges the neighbor nodes included in the neighbor list of the active node based on values of the fitness parameters determined in operation 620. In operation 640, the apparatus 300 selects a predetermined number of neighbor nodes from the neighbor nodes included in the neighbor list of the active node according to the arrangement performed in operation 630. The predetermined number may be a size of the neighbor list previously determined by a user.

In the selecting of the predetermined number of neighbor nodes (operation 630), the apparatus 300 divides the arranged neighbor nodes into high-fitness neighbor nodes and low-fitness neighbor nodes based on the fitness parameters, selects all of the high-fitness neighbor nodes and some of the low-fitness neighbor nodes. However, it is understood that aspects of the present invention are not limited to this method of selecting the predetermined number of neighbor nodes. For example, according to other aspects, the apparatus 300 may select a predetermined number of neighbor nodes from each of a plurality of high-fitness neighbor nodes and a plurality of low-fitness neighbor nodes in an order of value of degrees of fitness or at random.

FIG. 7 is a flowchart illustrating a method of determining fitness parameters, according to an embodiment of the present invention. Referring to FIG. 7, in operation 710, an apparatus for managing neighbor nodes (such as the apparatus 300 of FIG. 3) receives a neighbor list of each parent node from the parent nodes. In operation 720, the apparatus 300 receives characteristic values of neighbor nodes included in the neighbor list of each of the parent nodes from the neighbor node. In operation 730, the apparatus calculates fitness parameters using a predetermined equation, which may take various forms according to aspects of the present invention.

FIG. 8 is a flowchart illustrating a method of updating a neighbor list of an active node, according to an embodiment of the present invention. Referring to FIG. 8, in operation 810, an apparatus for managing neighbor nodes (such as the apparatus 300 of FIG. 3) arranges neighbor nodes included in a neighbor list of an active node and neighbor nodes included in a neighbor list of each of a plurality of parent nodes based on fitness parameters determined in operations 710 through 730 illustrated in FIG. 7. In operation 820, the apparatus selects a predetermined number of neighbor nodes from the neighbor nodes included in the neighbor list of the active node and the neighbor nodes included in the neighbor list of each of the parent nodes according to the arrangement performed in operation 810. Specifically, the apparatus 300 of FIG. 3 may divide the arranged neighbor nodes into high-fitness neighbor nodes and low-fitness neighbor nodes based on the fitness parameters and then select all of the high-fitness neighbor nodes and some of the low-fitness neighbor nodes. However, it is understood that aspects of the present invention are not limited to this method of selecting the predetermined number of neighbor nodes. For example, according to other aspects, the apparatus 300 may select a predetermined number of neighbor nodes from each of a plurality of high-fitness neighbor nodes and a plurality of low-fitness neighbor nodes in an order of value of degrees of fitness or at random. In operation 830, the apparatus 300 updates the neighbor list of the active node using the neighbor nodes selected in operation 820.

As described above, according to aspects of the present invention, by managing a neighbor list including information about neighbor nodes and updating the neighbor list based on fitness parameters, a node having a similar characteristic to that of the active node can be found within a minimum period of time without using a server. Moreover, according to aspects of the present invention, by dividing neighbor nodes into high-fitness neighbor nodes and low-fitness neighbor nodes, a node having a similar characteristic to that of the active node can be found quickly.

A program for executing the method of managing a neighbor node by an active node according to aspects of the present invention can be embodied as a computer-readable code on a computer-readable recording medium to be implemented using one or more computers and/or processors. The computer-readable recording medium is a data storage device that can store data which can be thereafter read by a computer system. Examples of computer-readable recording media include read-only memory (ROM), random-access memory (RAM), CD-ROMs, magnetic tapes, floppy disks, and optical data storage devices. The computer-readable recording medium can also be distributed over a network of coupled computer systems so that the computer-readable code is stored and executed in a decentralized fashion. Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of managing a neighbor node having a similar characteristic to that of an active node, the method comprising:
generating a neighbor list comprising information about neighbor nodes;
selecting parent nodes from among the neighbor nodes;
determining fitness parameters by using a characteristic value of the active node, characteristic values of the neighbor nodes included in the neighbor list of the active node, and characteristic values of neighbor nodes included in a neighbor list of each selected parent node; and
updating the neighbor list of the active node based on the fitness parameters.

2. The method as claimed in claim 1, wherein the information about the neighbor nodes comprises identifiers (IDs) and/or connection information of the neighbor nodes.

3. The method as claimed in claim 1, wherein the generating of the neighbor list comprises receiving the information about the neighbor nodes from a server that stores IDs and/or connection information of nodes that are currently connected to a network, or a node that is currently connected to the network without use of the server.

4. The method as claimed in claim 1, wherein the selecting of the parent nodes comprises:
receiving the characteristic values of the neighbor nodes included in the neighbor list of the active node;
determining preliminary fitness parameters using the characteristic value of the active node and the characteristic values of the neighbor nodes included in the neighbor list of the active node;
arranging the neighbor nodes included in the neighbor list of the active node based on values of the preliminary fitness parameters; and
selecting a predetermined number of parent nodes from the neighbor nodes included in the neighbor list of the active node according to the arranging.

5. The method as claimed in claim 4, wherein the selecting of the predetermined number of parent nodes comprises:
dividing the arranged neighbor nodes into high-fitness neighbor nodes and low-fitness neighbor nodes according to the values of the determined preliminary fitness parameters; and
selecting all of the high-fitness neighbor nodes and some of the low-fitness neighbor nodes.

6. The method as claimed in claim 1, wherein the determining of the fitness parameters comprises:
receiving the neighbor list of each parent node;
receiving characteristic values of the neighbor nodes included in the neighbor list of each parent node; and
calculating the fitness parameters using a predetermined equation relating the received characteristic values of the neighbor nodes included in the neighbor list of each parent node, the characteristic value of the active node, and the characteristic values of the neighbor nodes of the active node.

7. The method as claimed in claim 1, wherein the updating of the neighbor list of the active node comprises:
arranging the neighbor nodes included in the neighbor list of the active node and the neighbor nodes included in the neighbor list of each parent node according to values of the calculated fitness parameters;
selecting a predetermined number of neighbor nodes from the neighbor nodes included in the neighbor list of the active node and the neighbor nodes included in the neighbor list of each parent node according to the arranging; and
updating the neighbor list of the active node using the selected predetermined number of neighbor nodes.

8. The method as claimed in claim 7, wherein the selecting of the predetermined number of neighbor nodes comprises:
dividing the arranged neighbor nodes into high-fitness neighbor nodes and low-fitness neighbor nodes based on the values of the calculated fitness parameters; and
selecting all of the high-fitness neighbor nodes and some of the low-fitness neighbor nodes.

9. The method as claimed in claim 1, further comprising adding information about a node that accesses the active node to the neighbor list of the active node.

10. The method as claimed in claim 1, wherein the selecting of the parent nodes, the determining of the fitness parameters, and the updating of the neighbor list of the active node are repeated in a periodic manner and/or in response to an update request from a user.

11. An apparatus for managing a neighbor node having a similar characteristic to that of an active node, the apparatus comprising:
a neighbor list generation unit to generate a neighbor list comprising information about neighbor nodes;
a parent node selection unit to select parent nodes from among the neighbor nodes;
a fitness parameter determination unit to determine fitness parameters by using a characteristic value of the active node, characteristic values of the neighbor nodes included in the neighbor list of the active node, and characteristic values of neighbor nodes included in a neighbor list of each selected parent node; and
a neighbor list update unit to update the neighbor list of the active node according to values of the determined fitness parameters.

12. The apparatus as claimed in claim 11, wherein the information about the neighbor nodes comprises identifiers (IDs) and/or connection information of the neighbor nodes.

13. The apparatus as claimed in claim 11, wherein the neighbor list generation unit receives the information about the neighbor nodes from a server that stores IDs and/or connection information of nodes that are currently connected to a network, or a node that is currently connected to the network without use of the server.

14. The apparatus as claimed in claim 11, wherein the parent node selection unit comprises:
a characteristic value reception unit to receive the characteristic values of the neighbor nodes included in the neighbor list of the active node;
a parameter determination unit to determine preliminary fitness parameters using the characteristic value of the active node and the characteristic values of the neighbor node included in the neighbor list of the active node;
a node arrangement unit to arrange the neighbor nodes included in the neighbor list of the active node according to values of the preliminary fitness parameters; and
a node selection unit to select a predetermined number of parent nodes from the neighbor nodes included in the neighbor list of the active node according to the arrangement.

15. The apparatus as claimed in claim 14, wherein the node selection unit divides the arranged neighbor nodes into high-fitness neighbor nodes and low-fitness neighbor nodes according to the values of the determined preliminary fitness parameters, and selects all of the high-fitness neighbor nodes and some of the low-fitness neighbor nodes.

16. The apparatus as claimed in claim 11, wherein the fitness parameter determination unit comprises:
a neighbor list reception unit to receive the neighbor list of each parent node;
a characteristic value reception unit to receive characteristic values of the neighbor nodes included in the neighbor list of each parent node; and
a parameter calculation unit to calculate the fitness parameters using a predetermined equation relating the received characteristic values of the neighbor nodes included in the neighbor list of each parent node, the characteristic value of the active node, and the characteristic values of the neighbor nodes of the active node.

17. The apparatus as claimed in claim 11, wherein the neighbor list update unit comprises:
a node arrangement unit to arrange the neighbor node included in the neighbor list of the active node and the neighbor nodes included in the neighbor list of each parent node based on the values of the determined fitness parameters;
a node selection unit to select a predetermined number of neighbor nodes from the neighbor nodes included in the neighbor list of the active node and the neighbor nodes included in the neighbor list of each parent node according to the arrangement; and
an update unit to update the neighbor list of the active node using the selected predetermined number of neighbor nodes.

18. The apparatus as claimed in claim 17, wherein the node selection unit comprises:
a division unit to divide the arranged neighbor nodes into high-fitness neighbor nodes and low-fitness neighbor nodes according to the values of the determined fitness parameters; and
a selection unit to select all of the high-fitness neighbor nodes and some of the low-fitness neighbor nodes.

19. The apparatus as claimed in claim 11, wherein the neighbor list update unit adds information about a node that accesses the active node to the neighbor list of the active node.

20. The apparatus as claimed in claim 11, further comprising a control unit to repeat an update of the neighbor list of the active node in a periodic manner and/or in response to an update request from a user.

21. A computer-readable recording medium having recorded thereon the method of claim 1 and implemented by a computer.
